(19) United States
(12) Patent Application Publication
(10) Pub. No.: US 2025/0269625 A1
(43) Pub. Date: Aug. 28, 2025

(54) COMPOSITE SOUND-ABSORBING MATERIAL

(71) Applicant: AMOGREENTECH CO., LTD., Gimpo-si (KR)

(72) Inventors: Chan KIM, Gimpo-si (KR); Seon-Ho JANG, Gimpo-si (KR); Hyo-Jung LEE, Gimpo-si (KR); Seoung-Hoon LEE, Gimpo-si (KR); Yun-Mi SO, Gimpo-si (KR)

(73) Assignee: AMOGREENTECH CO., LTD., Gimpo-si (KR)

(21) Appl. No.: 18/866,580

(22) PCT Filed: May 18, 2023
(86) PCT No.: PCT/KR2023/006762

§ 371 Date: Nov. 18, 2024

(30) Foreign Application Priority Data
May 18, 2022 (KR) 10-2022-0060576

(51) Int. Cl. B32B 5/26; B32B 5/02; B32B 7/12

(52) U.S. Cl. CPC B32B 5/26; B32B 5/022; B32B 7/12; B32B 2250/02; B32B 2250/20; B32B 2307/102; B32B 2307/7376

(57) ABSTRACT

Provided is a composite sound-absorbing material. The composite sound-absorbing material includes: a base layer comprising at least one first fiber; and a fiber sheet comprising at least one second fiber and arranged on at least one surface of the base layer, wherein the base layer and the fiber sheet are implemented to satisfy predetermined conditions. Accordingly, excellent heat blocking and excellent sound absorption across the entire sound range can simultaneously be realized. In addition, along with the heat blocking and sound absorption, excellent reduction in volume and weight also can simultaneously be realized.

### CROSS REFERENCE TO THE RELATED APPLICATIONS

This application is the national phase entry of International Application No. PCT/KR2023/006762, filed on May 18, 2023, which is based upon and claims priority to Korean Patent Application No. 10-2022-0060576, filed on May 18, 2022, the entire contents of which are incorporated herein by reference.

### TECHNICAL FIELD

The present invention relates to a sound-absorbing material, and more particularly, to a composite sound-absorbing material complexed with two or more layers.

### BACKGROUND

Sound-absorbing materials are products with the function of absorbing sound and are widely used in the fields of construction, automobile, and various industries, and are mainly used in the form of nonwoven fabrics.

Basic sound-absorbing materials take in sound wave energy, convert it into other kinetic energy such as vibration, convert it into heat energy, and absorb it into the atmosphere or sound-absorbing material itself to attenuate sound. In general, since the surrounding noise has various wavelengths, such as a low-pitched region of 300 Hz or less, a medium-pitched region of 300 Hz to 2,000 Hz, and a high-pitched region of 2,000 Hz or more for each wavelength band, various types of sound-absorbing materials are required to be converted into kinetic energy such as vibration.

In order to properly solve various types of noise sources such as automobiles, apartment noise between floors, classrooms, studios, and performance halls, various forms and structures of sound insulation materials and sound-absorbing materials are also applied.

As the mobility paradigm of automobiles has recently changed from internal combustion engines to electric motors, parts are decreasing by more than 30%, and the concept is changing from transportation purposes to various living spaces. Due to the design centered on the expansion of the interior space of the vehicle, the importance of sound absorption performance and multifunctional vehicle interior materials is increasing as the drive system, safety modules, and convenience facilities of the automobile including the battery are concentrated in a narrow space.

In addition to the noise generated by the engine, there are many other types of noise, including noise transmitted through audio equipment, tires, and wind noise generated during driving. Since electric vehicles have no engine sound, road surface noise, incoming wind noise, and high-frequency sound (high noise sensitivity) from electric motors are relatively big issues, and electric vehicles have a wider internal space than internal combustion engines, which amplifies noise through resonance, and use battery power to drive the vehicle and operate the internal temperature control system at the same time, affecting the mileage. Therefore, the importance of interior materials for internal temperature management is becoming more prominent.

As a method for reducing electric vehicle noise, a noise reduction method by applying sound absorbing and insulating materials is most often used, and most of the sound absorbing and insulating materials use porous materials such as PET nonwoven fabric, ultra-fine fabric, and urethane foam, and are thickly applied for insulation.

However, in the case of conventional noise reduction materials, noise reduction in the entire sound range was impossible, and there was a problem of large weight and volume. In this case, it causes several disadvantages, such as a decrease in fuel efficiency of the automobile as well as an increase in production costs.

Therefore, it is necessary to develop a sound-absorbing material that exhibits excellent heat blocking effects and excellent sound-absorbing effects in the entire sound range, while also exhibiting excellent volume reduction and lightweight effects.

### SUMMARY

### Technical Problem

The present invention has been devised in view of the above problems, and is directed to providing a composite sound-absorbing material that is complexed with two or more layers, and that exhibits excellent heat blocking effects and excellent sound-absorbing effects in the entire sound range.

In addition, the present invention is also directed to providing a composite sound-absorbing material that exhibits excellent heat blocking effects and excellent sound-absorbing effects in the entire sound range, while also exhibiting excellent volume reduction and lightweight effects.

### Technical Solution

In order to solve the above-mentioned problems, the present invention provides a composite sound-absorbing material including: a base layer including at least one first fiber; and a fiber sheet including at least one second fiber and arranged on at least one surface of the base layer, wherein the base layer and the fiber sheet satisfy a condition (1) below.

$$13.3 \leq {( a + \sqrt{b} )}^{2} \leq 583 \qquad ( 1 )$$

Where, a is the average diameter (μm) of the first fiber of the base layer, and b is the thickness (μm) of the fiber sheet.

According to an exemplary embodiment of the present invention, the base layer and the fiber sheet may satisfy a condition (1) below.

$$13.35 \leq {( a + \sqrt{b} )}^{2} \leq 233 \qquad ( 1 )$$

Where, a is the average diameter (μm) of the first fiber of the base layer, and b is the thickness (μm) of the fiber sheet.

In addition, the first fiber may have an average diameter of 0.5 to 10 μm, and the base layer may have an average thickness of 10 to 3,000 mm.

In addition, the second fiber may have an average diameter of 100 nm to less than 1,000 nm, and the fiber sheet may have an average thickness of 10 to 200 μm.

In addition, at least a part of the fiber sheet may be fused and fixed to at least one surface of the base layer.

In addition, the composite sound-absorbing material may further include a binder layer interposed between the base layer and the fiber sheet.

In addition, the fiber sheet may be disposed on both surfaces of the base layer.

In addition, the first fiber may include at least one selected from the group consisting of polyethylene phthalate, polybutylene terephthalate, polyethylene, polypropylene, polylactic acid, polyurethane, and nylon 6,6, and the base layer may include at least one of a melt-blend nonwoven fabric and a spun lace nonwoven fabric.

In addition, the second fiber may include at least one selected from the group consisting of polyvinylidene fluoride, nylon 6,6, polyacrylonitrile, polystyrene, polyurethane, polysulfone, polyvinyl alcohol, polyvinylidene fluoride, polyvinyl butyral, and polylactic acid, and the fiber sheet may be formed by accumulating predetermined fibers.

### Advantageous Effect

The composite sound-absorbing material according to the present invention may simultaneously exhibit excellent heat blocking and excellent sound absorption across the entire sound range. In addition, along with the heat blocking and sound absorption, excellent reduction in volume and weight also can simultaneously be realized.

### BRIEF DESCRIPTION OF THE DRAWINGS

FIG. 1 a cross-sectional schematic diagram of a composite sound-absorbing material according to an exemplary embodiment of the present invention.

FIG. 2 is a cross-sectional schematic diagram of a composite sound-absorbing material according to another exemplary embodiment of the present invention.

FIG. 3 is a scanning electron microscope (FE-SEM) photograph of a fiber sheet according to an exemplary embodiment of the present invention.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and same or similar reference numerals denote same elements.

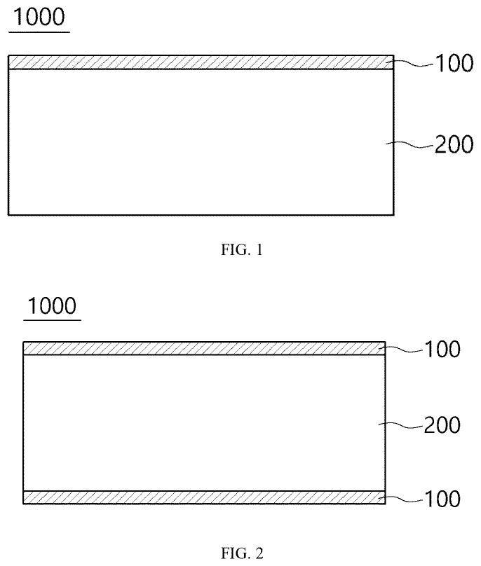

As shown in FIG. 1, a composite sound-absorbing material 1000 according to an exemplary embodiment of the present invention includes a base layer 200 including at least one first fiber, and a fiber sheet 100 including at least one second fiber and arranged on at least one surface of the base layer 200.

Before describing each component included in the composite sound-absorbing material of the present invention, the reason why the base layer and the fiber sheet included in the composite sound-absorbing material of the present invention should satisfy the following condition (1) will be described.

If the average diameter of the fibers constituting the base layer in the composite sound-absorbing material is too small, the sound-absorbing performance in the high-frequency region may deteriorate, and the lightweightness may decrease as the basis weight increases, and if the average diameter of the fibers constituting the base layer is too large, sound-absorbing performance in the high-frequency region may deteriorate. Furthermore, if the average thickness of the fiber sheet is too small, the heat blocking effect and the sound-absorbing performance in the medium and low sound region may decrease, and if the average thickness of the fiber sheet is too large, the volume may increase and the lightweightness may decrease.

Accordingly, the base layer and fiber sheet included in the composite sound-absorbing material should be implemented including fibers showing an appropriate fiber average diameter, and should show an appropriate thickness. The composite sound-absorbing material according to the present invention satisfies the following condition (1) in order to solve such a problem.

As a condition (1), it may be 13.3≤(a+\sqrt{b})²≤583, preferably 13.35≤(a+\sqrt{b})²≤233.

Where, a is the average diameter (μm) of the first fiber of the base layer, and b is the thickness (μm) of the fiber sheet.

IF (a+\sqrt{b})² is less than 13.3 under the above condition (1), sound-absorbing performance in the entire sound range may decrease, the heat blocking effect may decrease, and the lightweightness may decrease as the basis weight increases. In addition, if (a+\sqrt{b})² exceeds 583 under the above condition (1), sound-absorbing performance in the high-frequency region may deteriorate, and the lightweightness may decrease as the volume increases.

Hereinafter, each component included in the composite sound-absorbing material 1000 will be described in detail.

First, the base layer 200 will be described.

The base layer 200 serves as a base material of the composite sound-absorbing material 1000, and performs functions such as sound absorption in a high-frequency region, light weight and volume reduction of the composite sound-absorbing material 1000.

The base layer 200 may be implemented by including the first fiber as described above, and may preferably be a porous member formed of the first fiber, and for example, the base layer may be a nonwoven fabric, a fabric, or a cloth.

The fabric means that the fibers included in the fabric have a horizontal direction, and the specific tissue may be plain weave, twill weave, etc., and the density of warp and weft is not particularly limited. Also, the knitted fabric may be a known knit tissue, may be a weft knitted fabric, a warp knitted fabric, etc., and for example, may be a tricot in which yarns are warp knitted. In addition, as shown in FIG. 1, the base layer 200 may be a nonwoven fabric with no horizontal directionality in the first fiber; and may be a dry nonwoven fabric such as a chemical bonding nonwoven fabric, a thermal bonding nonwoven fabric, or an air-ray nonwoven fabric, or a nonwoven fabric manufactured by various methods such as wet nonwoven fabric, spun lace nonwoven fabric, needle punching nonwoven fabric, or melt blown nonwoven fabric; and may preferably be any one of a spun lace nonwoven fabric, a needle punching nonwoven fabric, and a melt blown nonwoven fabric, more preferably any one of a spun lace nonwoven fabric and a melt blown nonwoven fabric, and more preferably a melt blown nonwoven fabric.

The base layer 200 may have an average thickness of 10 to 3,000 mm, preferably 10 to 1,000 mm, in order to serve a base material, performs functions such as sound absorption in a high-frequency region, light weight and volume reduction of the composite sound-absorbing material 1000. If the average thickness of the base layer is less than 10 mm, sound absorbing performance in a high-frequency region may be deteriorated, and if the average thickness of the base layer exceeds 3,000 mm, lightweightness may be significantly reduced and volume may be significantly increased.

In addition, the first fiber may have an average diameter of 0.5 to 10 μm, preferably 0.5 to 3 μm, to satisfy the above-described condition (1). If the average diameter of the first fiber is less than 0.5 μm, sound-absorbing performance in a high-frequency region may deteriorate and lightweightness may deteriorate, and if the average diameter of the first fiber exceeds 10 μm, lightweightness and sound-absorbing performance in a high-frequency region may deteriorate.

If the first fiber is generally a material capable of forming a fiber and including the fiber to form a base layer, the material of the first fiber is not limited, and the first fiber may preferably include at least one selected from the group consisting of polyethylene phthalate, polybutylene terephthalate, polyethylene, polypropylene, polylactic acid, polyurethane and nylon 6,6, and more preferably include polypropylene.

Meanwhile, the base layer 200 may include a low melting point component to be bound to a fiber sheet described later without a separate adhesive or adhesive layer. When the base layer 200 is a cloth such as a nonwoven fabric, the first fiber may be made of a first composite fiber including a low melting point component. The first composite fiber may include a support component and a low melting point component such that at least a part of the low melting point component is exposed to an outer surface thereof. For example, it may be a sheath-core type composite fiber in which a support component forms a core part, and the sheath part surrounds the core part, or a side-by-side composite fiber in which a low melting point component is disposed on one side of a support component. The low melting point component and the support component may be a polyolefin-based component, for example, the support component may be polypropylene and the low melting point component may be polyethylene. The melting point of the low melting point component may be 60 to 180° C.

Next, a fiber sheet 100 disposed on at least one surface of the base layer 200 will be described.

The fiber sheet 100 performs functions such as heat blocking, sound absorption in a medium and low frequency region, lightweightness and volume reduction of the composite sound-absorbing material 1000.

The fiber sheet 100 is implemented by including the second fiber as described above, and may preferably be a porous member made of the second fiber, and more preferably, the fiber sheet may be a member having a three-dimensional network structure formed by randomly stacking cloth, fabric, or spun fibers in three dimensions.

In order for the fiber sheet 100 to perform functions such as heat blocking, sound absorption in a medium and low frequency region, lightweightness and volume reduction of the composite sound-absorbing material 1000, the second fiber may have an average diameter of 100 nm to less than 1,000 nm, preferably 100 nm to 800 nm, and more preferably 100 nm to 500 nm. If the average diameter of the second fiber is less than 100 nm, the lightweightness of the composite sound-absorbing material may decrease, and if the average diameter is equal to or more than 1,000 nm, the heat blocking and sound-absorbing performance in a medium and low frequency region may decrease as the pore increases.

The fiber sheet 100 may have an average thickness of 10 to 200 μm, preferably an average thickness of 10 to 150 μm, to satisfy the above-described condition (1). If the average thickness of the fiber sheet is less than 10 μm, the heat blocking effect and the sound-absorbing performance in the medium and low sound region may decrease, and if the average thickness of the fiber sheet is more than 200 μm, the volume may increase and the lightweightness may decrease.

If the second fiber is generally a material capable of forming a fiber and including the fiber to form a fiber sheet, the material of the second fiber is not limited, but in order to achieve the object of the present invention, the second fiber may preferably include at least one selected from the group consisting of polyvinylidene fluoride, nylon 6,6, polyacrylonitrile, polystyrene, polyurethane, polysulfone, polyvinyl alcohol, polyvinylidene fluoride, polyvinyl butyral, and polylactic acid, and more preferably include polyvinylidene fluoride (PVDF). The PVDF may have a weight average molecular weight of, for example, 300,000 to 500,000, and thus may be advantageous to achieve the object of the present invention.

Meanwhile, as shown in FIG. 2, the fiber sheet 100 may be disposed on both surfaces of the base layer 200. In this case, the composite sound-absorbing material may have a more excellent heat blocking and sound-absorbing effect in the entire sound range.

Meanwhile, the fiber sheet 100 may include a low melting point component to be bound to a fiber sheet described later without a separate adhesive or adhesive layer. When the fiber sheet 100 is a member having a three-dimensional network structure formed by randomly stacking spun fibers in three dimensions, the second fiber may be made of a second composite fiber including a low melting point component. The second composite fiber may include a support component and a low melting point component such that at least a part of the low melting point component is exposed to an outer surface thereof. For example, it may be a sheath-core type composite fiber in which a support component forms a core part, and the sheath part surrounds the core part, or a side-by-side composite fiber in which a low melting point component is disposed on one side of a support component. The low melting point component may be a polyolefin-based component, for example, the low melting point component may be polyethylene. The melting point of the low melting point component may be 60 to 180° C.

Meanwhile, the composite sound-absorbing material 1000 according to an exemplary embodiment of the present invention may further include a binder layer interposed between the base layer 200 and the fiber sheet 100.

The binder layer performs a function of fixing the base layer 200 and the fiber sheet 100. As the binder layer, any material capable of fixing between two layers implemented in the art, including fibers, may be used without limitation, and the binder layer may preferably include at least one selected from the group consisting of polyvinyl butyral (PVB), polyvinyl alcohol-based (PVA), and low melting point PET, and more preferably include polyvinyl butyral (PVB).

The above-described composite sound-absorbing material 1000 may be manufactured by a manufacturing method described below, but is not limited thereto.

First, as the fiber sheet 100, a member of a three-dimensional network structure formed by randomly stacking spun fibers in three dimensions, or a method of forming a three-dimensional network-shaped fiber web with fibers can be used without limitation. For example, as the spinning may be electrospinning, it may be produced by discharging a spinning solution containing a fiber-forming component with a spinning nozzle while applying air in the same direction as the spinning direction of the spinning nozzle adjacent to the outer circumference of the spinning nozzle to manufacture a fiber sheet.

The spinning solution may include a fiber-forming component and a solvent. It is desirable that the fiber-forming component is contained in an amount of 5 to 30% by weight, preferably 8 to 20% by weight in the spinning solution, and if the fiber-forming component is less than 5% by weight, it is difficult to form fibers, and although the spinning is not spun in a fibrous form but is sprayed in a droplet state to form a film shape or perform spinning, a large amount of beads are formed and the solvent is not easily volatilized, and thus pores may be blocked in a calendering process to be described later. In addition, if the fiber-forming component exceeds 30 wt %, the viscosity may increase and solidification may occur on the surface of the solution, making long-term spinning difficult, and the fiber diameter may increase, making it impossible to make a fibrous form with a size of less than micrometers.

As the solvent, a solvent that does not produce a precipitate while dissolving the fiber-forming component and does not affect the spinnability of fibers described later may be used without limitation, it may preferably include at least one selected from the group consisting of γ-butyrolactone, cyclohexanone, 3-hexanone, 3-heptanone, 3-octanone, N-methylpyrrolidone, dimethylacetamide, acetone dimethyl sulfoxide, and dimethylformamide. As an example, the solvent may be a mixed solvent of dimethylacetamide and acetone. When the first solvent includes acetone and dimethylacetamide, the dimethylacetamide and acetone may be included in a weight ratio of 1:0.1 to 0.4, and preferably in a weight ratio of 1:0.15 to 0.35.

The above-described spinning solution may be electrospun using a conventional known electrospinning device. For example, as the electrospinning device, an electrospinning device having a single spinning pack with one spinning nozzle, a plurality of single spinning packs for mass production, or a spinning pack with a plurality of nozzles may be used. In addition, in the electrospinning method, dry spinning or wet spinning with external coagulation tank may be used, and there is no limitation on the method.

Meanwhile, in order to achieve the object of the present invention, the electrospinning may be performed under conditions of an applied voltage of 10 to 30 kV, a distance of 10 to 30 cm between a spinning nozzle and a collector, a discharge rate of 0.02 to 0.08 cc/ghole per minute, a temperature of 10 to 50° C., and a relative humidity of 40 to 80%, preferably under conditions of an applied voltage of 15 to 25 kV, a distance of 15 to 25 cm between a spinning nozzle and a collector, a discharge rate of 0.03 to 0.07 cc/ghole per minute, a temperature of 15 to 45° C., and a relative humidity of 45 to 75%.

Thereafter, the second fiber formed through the spinning may be thermally fused to form a fiber assembly. The second fiber formed by spinning through the electrospinning is accumulated to form a three-dimensional network structure, and may be applied to the second fiber in which heat and/or pressure are accumulated to have a desired thickness or the like. The heat and/or pressure may be used without limitation as long as the method is capable of thermally fusing polymer-derived fibers that may be generally used in the art, and preferably, may be performed by calendering through a heated roller. In this case, the temperature of heat applied through the calendering may be 70 to 190° C., preferably 120 to 180° C.

Next, a step of placing and laminating the fiber sheet 100 on at least one surface of the base layer 200 may be performed.

The lamination may be performed by applying at least one of heat and pressure, and a specific method of applying at least one of the heat and pressure may adopt a known method, a conventional calendering process may be used as a non-limiting example, and the applied heat temperature may be 70 to 190° C. In addition, when performing a calendering process, it may be divided into several orders and performed multiple times, or for example, after the first calendering, the second calendering may be performed. In this case, the degree of heat and/or pressure applied in each calendering process may be the same or different. Through the laminating step, binding may occur between the fiber sheet and the base layer through thermal fusion, and a separate adhesive or adhesive layer may be omitted.

### MODES OF THE INVENTION

The present invention will be described in more detail through the following examples, but the following examples are not intended to limit the scope of the present invention, which should be construed to aid understanding of the present invention.

### Example 1

First, a spinning solution was prepared by dissolving polyvinylidene fluoride (PVDF) as a fiber-forming component in a mixed solvent of 80 wt % of dimethylacetamide and 20 wt % of acetone as a solvent to be 15 wt % based on the total weight of the spinning solution.

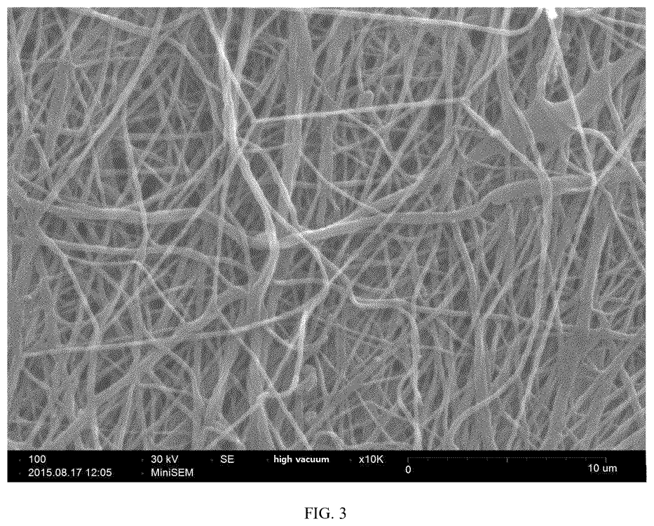

The prepared spinning solution was transferred to a spinning nozzle pack and electrospinning was performed in a spinning atmosphere with an applied voltage of 20 kV, a distance of 20 cm between a spinning nozzle and a collector, a discharge rate of 0.05 cc/g/hole per minute, and a temperature of 30° C. and a relative humidity of 60% to obtain a second fiber with an average fiber diameter of 300 nm (FIG. 3). The accumulated second fiber was then subjected to a calendering process using a roller heated to 150° C. to prepare a fiber sheet with an average thickness of 20 μm and a basis weight of 40 g/m² in which the second fiber was heat-fused.

After that, a melt blown nonwoven fabric with an average thickness of 10 cm and a basis weight of 150 g/m² formed of a first fiber with an average diameter of 3 μm, which is polypropylene, was prepared as a base layer. The prepared fiber sheet and base layer were fixed to each other by hot air using an unweighted binder roll, thereby preparing a composite sound-absorbing material as shown in FIG. 1. In this case, the binder was polyvinyl butyral (PVB), and the hot air temperature was 100° C.

### Examples 2 to 9 and Comparative Examples 1 to 4

A sound-absorbing material was prepared in the same manner as in Example 1, except by changing the average diameter (thickness fixed) of the first fiber of the base layer, the thickness of the fiber sheet (basis weight fixed per thickness), and whether the base layer and the fiber sheet were included as shown in Tables 1 and 2.

### Experimental Example

The following physical properties were evaluated for the sound-absorbing materials prepared according to Examples and Comparative Examples, and are shown in Tables 1 and 2, respectively.

### 1. Heat Blocking Evaluation

For each sound-absorbing material prepared in Examples and Comparative Examples, the reflectance in the near-infrared (780 to 2500 nm) region was measured using UV-Vis-NIR Spectroscopy, and then the average blocking rate in the near-infrared (780 to 2500 nm) region was measured to evaluate the heat blocking.

### 2. Evaluation of Sound Absorption Characteristics for Each Frequency

For each sound-absorbing material prepared in Examples and Comparative Examples, the sound absorption coefficients for each frequency were calculated by the following calculation formula at frequencies of 200 Hz, 1,000 Hz, 2,000 Hz, 8,000 Hz, and 10,000 Hz according to the KS F 2814 method, and the sound-absorbing characteristics for each frequency were evaluated.

$$Sound absorption coefficient = ( Incident Sound Intensity - Reflective Sound Intensity ) / Incident Sound Intensity \qquad [ Calculation formula ]$$

### 3. Lightweightness Evaluation

For each sound-absorbing material prepared in Examples and Comparative Examples, the weight of each sound-absorbing material was measured, and then the lightweightness was evaluated by measuring the weight of the sound-absorbing materials according to the remaining Examples and Comparative Examples based on the weight of the sound-absorbing material of Example 1 as 100.

TABLE 1

| | | | Example | Example | Example | Example | Example | Example |
|---|---|---|---|---|---|---|---|---|
| Classification | | | 1 | 2 | 3 | 4 | 5 | 6 |
| Base layer | First fiber | | 3 | 1 | 3 | 9.5 | 0.3 | 12 |
| | average | | | | | | | |
| | diameter | | | | | | | |
| | (μm) | | | | | | | |
| Fiber sheet | Thickness | | 20 | 13 | 140 | 190 | 20 | 20 |
| | (μm) | | | | | | | |
| Condition (1), (a + b^{1/2})² | | | 55.83 | 21.21 | 219.99 | 542.15 | 22.77 | 271.33 |
| Heat | Average | | 70 | 69 | 92 | 94 | 70 | 69 |
| blocking | blocking rate | | | | | | | |
| evaluation | (%) | | | | | | | |
| Sound | 200 | Hz | 0.330 | 0.326 | 0.382 | 0.382 | 0.329 | 0.330 |
| absorption | 1,000 | Hz | 0.874 | 0.834 | 0.832 | 0.830 | 0.872 | 0.871 |
| coefficient | 2,000 | Hz | 0.731 | 0.725 | 0.777 | 0.769 | 0.731 | 0.730 |
| | 8,000 | Hz | 0.784 | 0.795 | 0.786 | 0.732 | 0.706 | 0.697 |
| | 10,000 | Hz | 0.834 | 0.832 | 0.832 | 0.806 | 0.639 | 0.624 |

| | | | | | | |
|---|---|---|---|---|---|---|
| Lightweightness evaluation | 100 | 90 | 271.43 | 342.86 | 35.71 | 314.29 |

TABLE 2

| | | | | | Comparative | Comparative | Comparative | Comparative |
|---|---|---|---|---|---|---|---|---|
| | | | Examples | Examples | Example | Example | Example | Example |
| Classification | | | 7 | 8 | 1 | 2 | 3 | 4 |
| Base layer | First fiber | | 3 | 3 | 0.3 | 11 | — | 3 |
| | average | | | | | | | |
| | diameter | | | | | | | |
| | (μm) | | | | | | | |
| Fiber sheet | Thickness | | 5 | 220 | 5 | 210 | 20 | — |
| | (μm) | | | | | | | |
| Condition (1), (a + b^{1/2})² | | | 27.42 | 317.99 | 6.43 | 649.81 | — | — |
| Heat | Average | | 35 | 94 | 34 | 94 | 68 | 13 |
| blocking | blocking rate | | | | | | | |
| evaluation | (%) | | | | | | | |
| Sound | 200 | Hz | 0.124 | 0.386 | 0.120 | 0.381 | 0.307 | 0.073 |
| absorption | 1,000 | Hz | 0.422 | 0.829 | 0.420 | 0.830 | 0.852 | 0.237 |
| coefficient | 2,000 | Hz | 0.696 | 0.766 | 0.696 | 0.761 | 0.702 | 0.415 |
| | 8,000 | Hz | 0.704 | 0.786 | 0.684 | 0.673 | 0.266 | 0.653 |
| | 10,000 | Hz | 0.837 | 0.836 | 0.610 | 0.599 | 0.298 | 0.531 |

| | | | | | | |
|---|---|---|---|---|---|---|
| Lightweightness evaluation | 78.57 | 385.71 | 14.29 | 561.91 | 28.57 | 71.43 |

As can be seen in Table 1 and Table 2, Examples 1 to 5, which satisfy the average diameter of the first fiber of the base layer, the thickness of the fiber sheet, and whether the base layer and the fiber sheet are included according to the present invention, have excellent heat blocking and sound-absorbing performance and excellent lightweightness compared to Examples 6 to 9 and Comparative Examples 1 to 4, which do not satisfy any of these.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

### NATIONAL RESEARCH AND DEVELOPMENT PROJECT THAT SUPPORTED THIS INVENTION

[Assignment Unique Number] 1425159097
[Assignment Number] S2841718
[Name of the Ministry] Ministry of SMEs and Startups, Republic of Korea
[Assignment management (professional) organization name] Korea Technology and Information Promotion Agency for SMEs
[Research Project Name] SMEs Technology Innovation Development Project (market expansion type)
[Research Assignment Name] Development of smart mask technology with forced circulation filter for the face
[Contribution rate] 1/1
[Name of Project Carrying Out Organization] Amogreentech Co., LTD
[Research Period] 2020. 06. 01 to 2022. 05. 31

What is claimed is:

1. A composite sound-absorbing material, comprising:
a base layer comprising at least one first fiber; and
a fiber sheet comprising at least one second fiber and arranged on at least one surface of the base layer,
wherein the base layer and the fiber sheet satisfy a first condition below:
$$13.3 \leq {( a + \sqrt{b} )}^{2} \leq 583$$
wherein a is an average diameter of the at least one first fiber of the base layer, b is a thickness of the fiber sheet, and a unit of the a and the b is micron.

2. The composite sound-absorbing material of claim 1,
wherein the base layer and the fiber sheet satisfy a second condition (1) below:
$$13.35 \leq {( a + \sqrt{b} )}^{2} \leq 233$$
wherein the a is the average diameter of the at least one first fiber of the base layer, and the b is the thickness of the fiber sheet.

3. The composite sound-absorbing material of claim 1,
wherein the at least one first fiber has the average diameter of 0.5 to 10 μm, and the base layer has an average thickness of 10 to 3,000 mm.

4. The composite sound-absorbing material of claim 1,
wherein the at least one second fiber has an average diameter of 100 nm to less than 1,000 nm, and the fiber sheet has an average thickness of 10 to 200 μm.

5. The composite sound-absorbing material of claim 1,
wherein a part of the fiber sheet is fused and fixed to the at least one surface of the base layer.

6. The composite sound-absorbing material of claim 1,
further comprising a binder layer interposed between the base layer and the fiber sheet.

7. The composite sound-absorbing material of claim 1,
wherein the fiber sheet is disposed on both surfaces of the base layer.

8. The composite sound-absorbing material of claim 1,
wherein the at least one first fiber comprises at least one selected from the group consisting of polyethylene phthalate, polybutylene terephthalate, polyethylene, polypropylene, polylactic acid, polyurethane, and nylon 6,6, and the base layer comprises at least one of a melt-blend nonwoven fabric and a spun lace nonwoven fabric.

9. The composite sound-absorbing material of claim 1,
wherein the at least one second fiber comprises at least one selected from the group consisting of polyvinylidene fluoride, nylon 6,6, polyacrylonitrile, polystyrene, polyurethane, polysulfone, polyvinyl alcohol, polyvinylidene fluoride, polyvinyl butyral, and polylactic acid, and the fiber sheet is formed by accumulating predetermined fibers.
